(19) United States
(12) Patent Application Publication
(10) Pub. No.: US 2023/0103869 A1
(43) Pub. Date: Apr. 6, 2023

(54) COMPONENT FOR A WATER BEARING APPLIANCE AND METHOD FOR PRODUCING SUCH COMPONENT

(71) Applicant: Electrolux Appliances Aktiebolag, Stockholm (SE)

(72) Inventors: Luca Crema, Porcia (IT); Massimo Sanità, Porcia (IT)

(73) Assignee: Electrolux Appliances Aktiebolag, Stockholm (SE)

(21) Appl. No.: 17/799,371

(22) PCT Filed: Jan. 28, 2021
(86) PCT No.: PCT/EP2021/051919

§ 371 Date: Aug. 12, 2022

(30) Foreign Application Priority Data
Feb. 19, 2020 (EP) 20158354.9

(51) Int. Cl. B29C 45/16; D06F 39/12; D06F 34/28; A47L 15/42; B32B 27/08; B32B 27/32; B32B 27/30

(52) U.S. Cl. CPC B29C 45/16; D06F 39/12; D06F 34/28; A47L 15/4251; A47L 15/4293; B32B 27/08; B32B 27/32; B32B 27/302; B29K 2105/26

(57) ABSTRACT

An aesthetic component for a water bearing appliance. The component comprises a first polymeric material and a second polymeric material. The external surface of the component is at least partially constituted by the first polymeric material and the first polymeric material covers the second polymeric material. The second polymeric material comprises a recycled polymeric material.

The present invention concerns the production of components for water bearing appliances, in particular components for laundry or dish washing machines or driers.

Specifically, the invention relates to an aesthetic component made of polymeric material for washing machines, in particular laundry or dish washing machines.

More particularly, the invention relates to a casing component made of polymeric material for laundry or dish washing machines.

### BACKGROUND ART

Nowadays the use of plastic components in water bearing appliances such as laundry washing machines or laundry washing-drying machines or driers or dish washing machines, is widespread.

Components made of plastic typically comprise washing tubs, external casings of the machines or part thereof, like for example a user control panel, a filter door, a door frame, etc.

Known plastic components used in such machines are made of recycled plastic, i.e. waste plastic processed for reuse. However, components made of recycled plastic may worsen the aesthetic appearance of the components themselves and/or negatively affect mechanical properties compare to components made of not recycled plastic.

Nevertheless, all efforts aimed at using recycled materials are highly appreciated.

It is an object of the invention to optimize aesthetics and/or mechanics characteristics of plastic components for water bearing appliances on the base of the type of plastic material used in the producing process.

It is another object of the invention to implement a water bearing appliance component which has reduced production cost compared to known water bearing appliance components.

It is a further object of the invention to implement a water bearing appliance that reduces the environmental impact in terms of plastic materials used for its production.

### DISCLOSURE OF INVENTION

Applicant has found that by providing a component for a water bearing appliance comprising a recycled polymeric material, it is possible to reach the mentioned objects.

In a first aspect thereof the present invention relates, therefore, to an aesthetic component for a water bearing appliance, wherein the component comprises a first polymeric material and a second polymeric material, the external surface of said component being at least partially constituted by said first polymeric material and said first polymeric material covering said second polymeric material, wherein said second polymeric material comprises a recycled polymeric material.

An aesthetic component is a component having a surface visible from outside when said component is assembled on the laundry/dish washing machine.

Advantageously, the component of the invention may be manufactured with low cost thanks to the use of a recycled material.

Still advantageously, the use of recycled materials to produce the component reduces the environmental impact in terms of plastic materials consumption and in terms of re-use/recycling of waste plastic materials.

In a preferred embodiment of the invention, the first polymeric material comprises a not recycled polymeric material.

Advantageously, the aesthetic appearance of the component is significantly improved thanks to the use of a not recycled material, namely the external layer of first polymeric material.

According to a preferred embodiment of the invention, the external surface of the component is completely constituted by the first polymeric material and the first polymeric material completely covers the second polymeric material.

Preferably, the first polymeric material and/or the second polymeric material comprises polymers.

In a preferred embodiment of the invention, the first polymeric material and/or the second polymeric material comprises a thermoplastic material.

Preferably, the recycled material derives from post-consumer plastic and/or post-industrial plastic materials.

In a preferred embodiment of the invention, said recycled material comprises a polymeric material comprising one or more chemical elements of the group comprising the following chemical elements: Lead; Cadmium; Mercury;

Hexavalent Chromium; Bromine; Antimony; Arsenic; wherein said one or more chemical elements can be found in a quantity inside said recycled material above, or equal to, a minimum threshold.

Preferably, said minimum threshold for Lead is 7 ppm and/or said minimum threshold for Cadmium is 5 ppm and/or said minimum threshold for Mercury is 0.01 ppm and/or said minimum threshold for Hexavalent Chromium is 10 ppm and/or said minimum threshold for Bromine is 5 ppm and/or said minimum threshold for Antimony is 5 ppm and/or said minimum threshold for Arsenic is 5 ppm.

In a preferred embodiment of the invention, said one or more chemical elements can be found in a quantity inside said recycled material below, or equal to, a maximum threshold.

When the recycled material derives from polyolefin polymers, said maximum threshold for Lead is 60 ppm and/or said maximum threshold for Cadmium is 20 ppm and/or said maximum threshold for Mercury is 0.5 ppm and/or said maximum threshold for Hexavalent Chromium is 20 ppm and/or said maximum threshold for Bromine is 60 ppm and/or said maximum threshold for Antimony is 50 ppm and/or said maximum threshold for Arsenic is 50 ppm.

When the recycled material derives from Styrenic polymers, said maximum threshold for Lead is 90 ppm and/or said maximum threshold for Cadmium is 40 ppm and/or said maximum threshold for Mercury is 10 ppm and/or said maximum threshold for Hexavalent Chromium is 100 ppm and/or said maximum threshold for Bromine is 100 ppm and/or said maximum threshold for Antimony is 200 ppm and/or said maximum threshold for Arsenic is 200 ppm.

Advantageously, impurity chemical elements falling within these maximum thresholds guarantee a good standard in term of mechanical properties (stiffness, strength, etc) to the component.

Advantageously, the first polymeric material and said the polymeric material form a one-piece monolithic body.

In a preferred embodiment of the invention, the first polymeric material and the second polymeric material are co-injected material resulting from co-injection moulding process.

Co-injection moulding process is a polymer injection technology in which different polymers are injected, one after the other, into the same mould.

Advantageously, co-injection moulding process provides a cost-effective solution when two materials needs to be linked one to the other.

Preferably, said component is one of: a casing component of said water bearing appliance, a control panel of said water bearing appliance.

According to the invention, the water bearing appliance is preferably a water bearing household appliance, more preferably a laundry washing machine or a laundry washing-drying machine or a drier or a dish washing machine.

In a further aspect thereof, the present invention concerns a method for producing an aesthetic component as described above, wherein the method comprises the steps of:
injecting from at least one injection point said first polymeric material into a cavity of a mould for a first time so that said first polymeric material reaches internal surfaces of said mould and at least partially solidifies to form an external solidified layer;
injecting from said at least one injection point, after said first time, said second polymeric material into said mould for a second time so that said second polymeric material fills the core of said cavity and pushes the first polymeric material not jet solidified.

In a preferred embodiment of the invention, the second polymeric material pushes the first polymeric material not jet solidified so that the first polymeric material reaches all remaining internal surfaces of said mould where at least partially solidifies and forms an external solidified layer.

In a different preferred embodiment of the invention, the second polymeric material pushes the first polymeric material not jet solidified so that the first polymeric material reaches some remaining internal surfaces of said mould where at least partially solidifies and forms an external solidified layer and so that the second polymeric material reaches all remaining internal surfaces of the mould where at least partially solidifies and forms an external solidified layer.

Said method carries out a co-injection moulding process wherein the first polymeric material and the second polymeric material are injected, one after the other, into the same mould.

### BRIEF DESCRIPTION OF THE DRAWINGS

Further characteristics and advantages of the present invention will be highlighted in greater detail in the following detailed description of preferred embodiments, provided with reference to the enclosed drawings. In the drawings, corresponding characteristics and/or components are identified by the same reference numbers. In particular:

FIG. 1 shows a perspective view of a component according to a preferred embodiment of the invention;

FIG. 2 is a cross section along line II°-II° of FIG. 1;

FIG. 3 is an enlarged view of a detail of FIG. 2;

FIG. 4 shows a mould used to produce a component according to the invention;

FIG. 5 shows a first phase for producing a component using the mould of FIG. 4 according to the invention;

FIG. 6 shows a second phase for producing a component using the mould of FIG. 4 according to the invention;

FIG. 7 shows a final phase for producing a component using the mould of FIG. 4 according to the invention;

FIG. 8 shows a further embodiment of FIG. 2 illustrating a component according to a further embodiment of the invention;

FIG. 9 is an enlarged view of a detail of FIG. 8;

FIGS. 10 to 12 show phases for producing the component of FIG. 8 using the mould of FIG. 4.

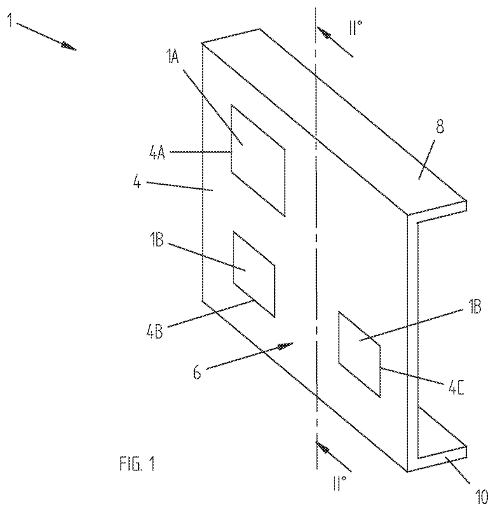

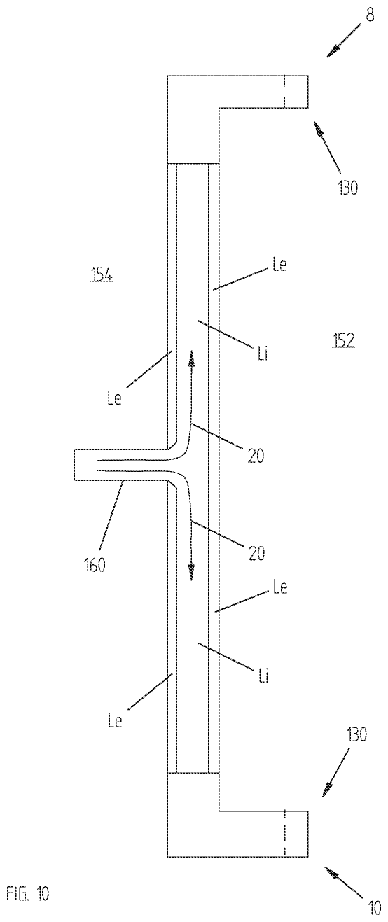

FIG. 8 shows a further embodiment of the component of FIG. 1;

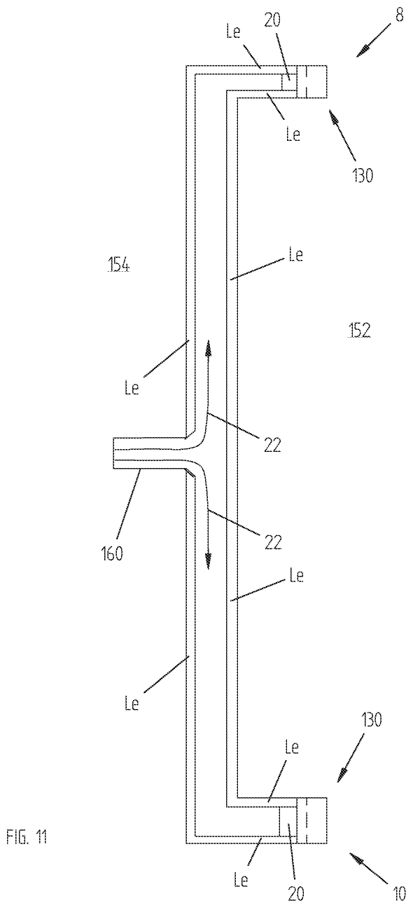

FIG. 9 the component of FIG. 8 from another point of view;

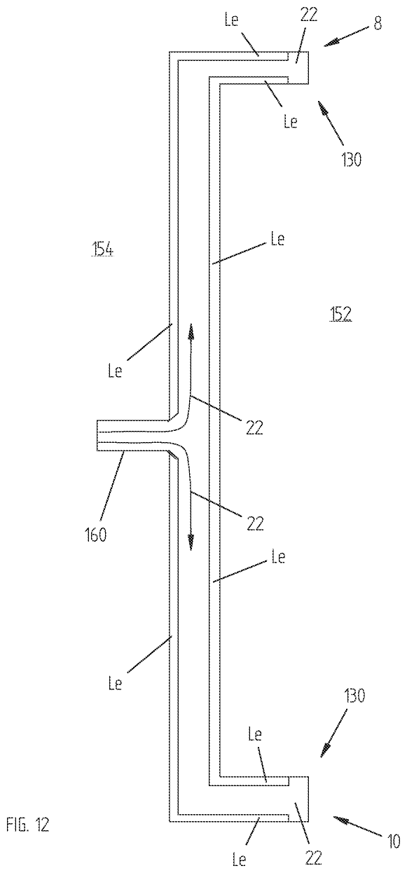

FIG. 10 is a cross section along line X°-X° of FIG. 8.

FIG. 13 shows a further embodiment of the component of FIG. 1;

FIG. 14 is a cross section along line XIV°-XIV° of FIG. 13;

FIG. 15 shows a further embodiment of the component of FIG. 1;

FIG. 16 is a cross section along line XVI°-XVI° of FIG. 15.

FIG. 16A is an enlarged view of a detail of FIG. 16.

### DETAILED DESCRIPTION OF A PREFERRED EMBODIMENT OF THE INVENTION

The present invention has proved to be particularly advantageous to produce a user control panel in washing machines, preferably laundry washing machines, as described below. It should in any case be underlined that the present invention is not limited to laundry washing machines. On the contrary, the present invention can be conveniently applied to any aesthetic component for water bearing appliances such as laundry washing machines or laundry washing-drying machines or driers or dish washing machines.

With reference to FIG. 1 a first preferred embodiment of a user control panel 1 according to the invention is shown.

The user control panel 1 is preferably arranged at a frontal panel of a laundry washing machine (not shown) so that a user may select and set washing parameters, like for example the desired washing program, the washing temperature, the spinning speed, etc. The user control panel 1 preferably comprises a display 1A and/or one or more selector devices 1B, 1C, for example a push button or a touch screen, which allow to select said parameters.

The user control panel 1 preferably comprises a support body 4 and apertures 4A, 4B, 4C to which the display 1A and the selector devices 1B, 1C may be fitted.

The support body 4 preferably has a substantially planar frontal surface 6 where the display 1A and the selector devices 1B, 1C are arranged. The support body 4 then preferably comprises two mounting ribs 8, 10 suited to mount the user control panel 1 to the frontal panel of the laundry washing machine.

The planar frontal surface 6 of the support body 4 represents the surface of the user control panel 1 which is visible from outside when the user control panel 1 is assembled on the laundry washing machine.

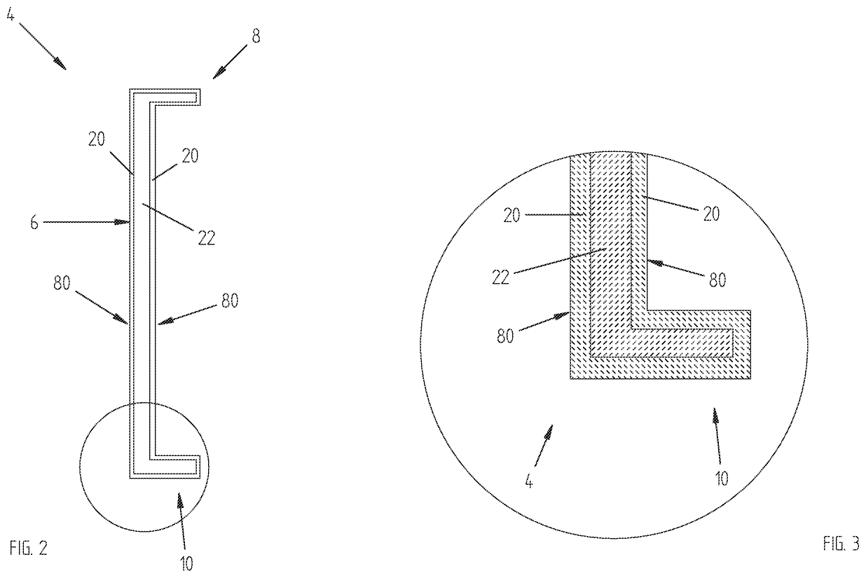

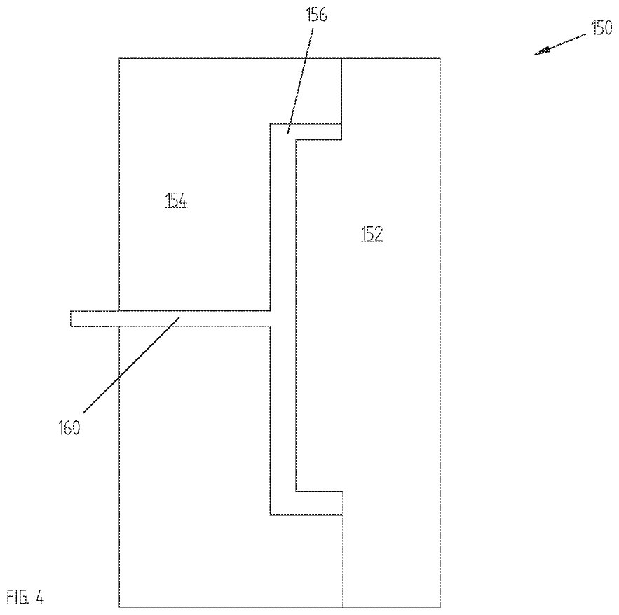

According to an aspect of the invention, the support body 4 preferably comprises a first polymeric material 20 and a second polymeric material 22, as better illustrated in FIGS. 2 and 3.

The first polymeric material 20 constitutes the external surface 80 of the support body 4 and covers the second polymeric material 22.

In the first preferred embodiment here described, the first polymeric material 20 constitutes the overall external surface 80 of the support body 4 and completely covers the second polymeric material 22.

The second polymeric material 22 constitutes the core of the support body 4 and is completely surrounded by the first polymeric material 20.

In a further preferred embodiment, for example the embodiment better described later with reference to FIGS. 8 to 12, the external surface of the support body is at least partially constituted by the first polymeric material and partially covers the second polymeric material. The second polymeric material constitutes the core of the support body and, in part, constitutes the external surface of the support body.

The support body 4 is preferably obtained through a continuous injection moulding process, or co-injection moulding process, wherein the first polymeric material 20 and the second polymeric material 22 are sequentially and continuously injected in a mould, as better described later. The first polymeric material 20 and the second polymeric material 22 form therefore a one-piece monolithic body.

Co-injection moulding process advantageously provides a cost-effective solution when two materials needs to be linked one to the other.

In a preferred embodiment of the invention, the first and/or the second polymeric material 20, 22 comprises polymers. Preferably, the first and/or the second polymeric material comprises a thermoplastic material.

According to an aspect of the invention, the first polymeric material 20 preferably comprises a not recycled polymeric material and the second polymeric material 22 preferably comprises a recycled polymeric material.

By the term “recycled material” it is meant that the material composing the recycled material has a lower degree of purity than that of a not recycled material.

Said recycled polymeric material preferably comprises a material deriving from post-consumer plastic and/or post-industrial plastic materials.

By the term “post-consumer plastic materials” it is meant the selected materials deriving from the separate collection of wastes, especially municipal solid wastes, preferably from packaging.

Another possible definition indicates that the “post-consumer plastic materials” are those materials which the consumer has stopped using and which may be solid, thrown away, or discharged as waste (The global Development Research Centre. Solid waste management. Glossary, http://glossaiy.eea.eui pa.eu), such as waste electrical and electronic equipment (WEEE) and waste from automotive industries.

By the term “post-industrial plastic” materials it is meant that such components are represented by industrial scraps and, i.e., by residues and/or scraps coming from or resulting from industrial processing of virgin plastic materials.

In a preferred embodiment, the recycled material deriving from plastic materials may be considered a polymeric material comprising one or more impurity chemical elements.

Preferably, the recycled material may be considered a polymeric material comprising one or more chemical elements of the group comprising the following chemical elements: Lead (Pb); Cadmium (Cd); Mercury (Hg); Hexavalent Chromium (Cr(VI)); Bromine (Br); Antimony (Sb); Arsenic (As); wherein said one or more elements can be found in a quantity inside the recycled material above a minimum threshold.

Preferably, each impurity chemical element can be found inside the recycled material in a minimum quantity as listed below:

Lead (Pb)≥7 ppm;

Cadmium (Cd)≥5 ppm;

Mercury (Hg)≥0.01 ppm;

Hexavalent Chromium (Cr(VI))≥10 ppm;

Bromine (Br)≥5 ppm;

Antimony (Sb)≥5 ppm;

Arsenic (As)≥5 ppm.

Furthermore, preferably, each impurity chemical element can be found inside the recycled material in a quantity below a maximum threshold. Therefore, preferably, each impurity chemical element can be found inside the recycled material in a quantity which is inside a preferred range.

In preferred embodiments, the recycled material may derive from polyolefin polymers, for example Polypropylene (PP) or Polyethylene (PE), or from Styrenic polymers, for example Polystyrene (PS) or Acrylonitrile-Butadiene-styrene (ABS).

When the recycled material derives from polyolefin polymers, for example, the recycled material may be considered a polymeric material comprising one or more impurity chemical elements which can be found inside the recycled material in a quantity according to table 1 below.

TABLE 1

| | Broad Range | Intermediate | Strict Range |
|---|---|---|---|
| Chemical element | (ppm) | Range (ppm) | (ppm) |
| Lead (Pb) | 7-1000 | 7-90 | 7-60 |
| Cadmium (Cd) | 5-100 | 5-40 | 5-20 |
| Mercury (Hg) | 0.01-1000 | 0.01-10 | 0.01-0.5 |
| Hexavalent Chromium | 10-1000 | 10-100 | 10-20 |
| Cr (VI) | | | |
| Bromine (Br) | 5-400 | 5-100 | 5-60 |
| Antimony (Sb) | 5-200 | 5-100 | 5-50 |
| Arsenic (As) | 5-1000 | 5-100 | 5-50 |

In a preferred embodiment and according to the Table 1 above, each impurity chemical element can be found inside the recycled material in a quantity below a maximum threshold as listed below:

Lead (Pb)≤60 ppm;

Cadmium (Cd)≤20 ppm;

Mercury (Hg)≤0.5 ppm;

Hexavalent Chromium (Cr(VI))≤20 ppm;

Bromine (Br)≤60 ppm;

Antimony (Sb)≤50 ppm;

Arsenic (As)≤50 ppm.

Preferably, impurity chemical elements falling within these maximum thresholds guarantee a good standard in term of mechanical properties (stiffness, strength, etc.) to the component.

When the recycled material derives from styrenic polymers, for example, the recycled material may be considered a polymeric material comprising one or more impurity chemical elements which can be found inside the recycled material in a quantity according to table 2.

TABLE 2

| | Broad Range | Intermediate | Strict Range |
|---|---|---|---|
| Chemical element | (ppm) | Range (ppm) | (ppm) |
| Lead (Pb) | 7-1000 | 7-100 | 7-90 |
| Cadmium (Cd) | 5-100 | 5-50 | 5-40 |
| Mercury (Hg) | 0.01-1000 | 0.01-10 | 0.01-0.5 |
| Hexavalent Chromium | 10-1000 | 10-200 | 10-100 |
| Cr (VI) | | | |
| Bromine (Br) | 5-400 | 5-200 | 5-100 |
| Antimony (Sb) | 5-700 | 5-300 | 5-200 |
| Arsenic (As) | 5-1000 | 5-800 | 5-500 |

In a preferred embodiment and according to the Table 2 above, each impurity chemical element can be found inside the recycled material in a quantity below a maximum threshold as listed below:

Lead (Pb)≤90 ppm;

Cadmium (Cd)≤40 ppm;

Mercury (Hg)≤0.5 ppm;

Hexavalent Chromium (Cr(VI))≤100 ppm;

Bromine (Br)≤100 ppm;

Antimony (Sb)≤200 ppm;

Arsenic (As)≤200 ppm.

Preferably, impurity chemical elements falling within these maximum thresholds guarantee a good standard in term of mechanical properties (stiffness, strength, etc.) to the component.

In a first advantageous aspect of the invention, the support body 4 may be manufactured with low cost thanks to the use of a recycled material but, at the same time, the aesthetic appearance of the support body 4 is significantly improved compared to known components thanks to the use of a not recycled material, namely the external layer of first polymeric material 20.

In a further advantageous aspect of the invention, the use of recycled materials to produce the component reduces the environmental impact in terms of plastic materials consumption and in terms of re-use/recycling of waste plastic materials.

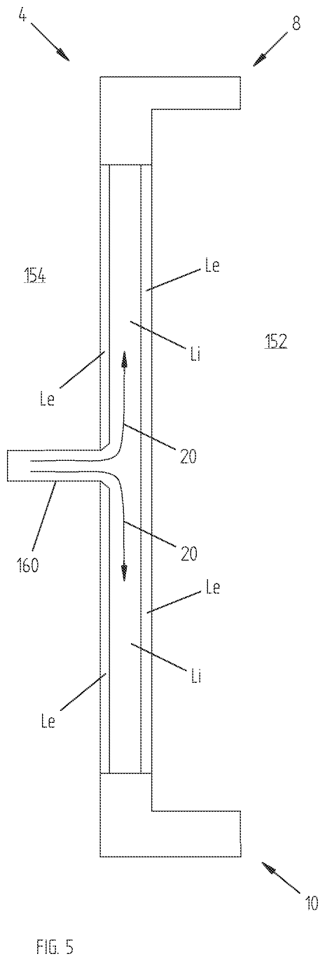

With reference to FIGS. 4 to 7 a method to obtain a support body 4 according to a preferred embodiment of the invention is described.

Preferably, a moulding injection process is used to obtain the support body 4, or co-injection moulding process.

FIG. 4 schematically shows a mould 150 used in a moulding injection process to obtain the support body 4.

The mould 150 preferably comprises two sides 152, 154 defining a cavity 156 with the desired shape of the support body 4. The mould 150 comprises at least one injection point/channel 160 through which molten polymeric material is forced into the mould cavity 156.

In different preferred embodiments, the mould may comprise a plurality of injection points/channels through which molten polymeric material is forced into the mould cavity.

The injection points/channels are preferably opportunely arranged to allow the more uniform distribution of the molten polymeric material inside the mould.

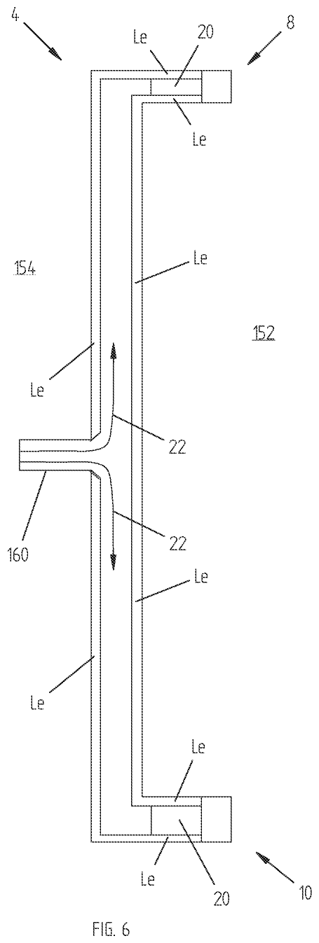

FIG. 5 shows a first phase of the injection process.

A first molten polymeric material 20, preferably a not recycled polymeric material, is forced into the mould cavity 156 via the injection point/channel 160.

The first polymeric material 20 injected into the cavity 156 that touches the internal surfaces (walls) of the mould 150 cools rapidly and at least partially polymerises due to the low wall temperature of the mould 150. At this stage, as illustrated in FIG. 5, an external layer Le of first solidified polymeric material 20 encloses a molten core Li of first polymeric material 20.

The first polymeric material 20 is injected into the cavity 156 for a first time T1.

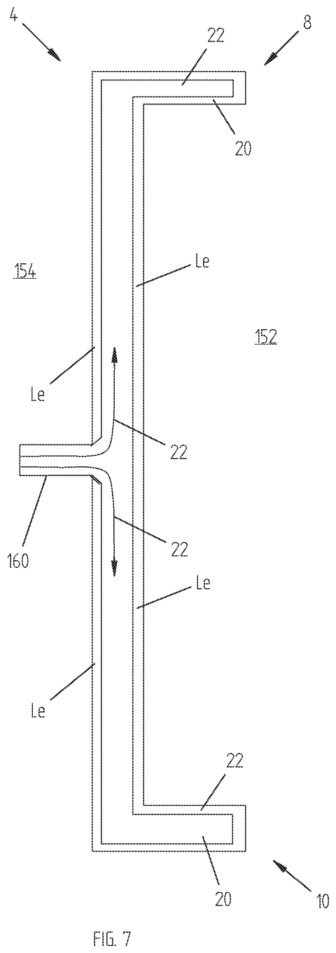

From the end of the first time T1 the second molten polymeric material 22, preferably a recycled polymeric material, is subsequentially and continuously forced into the mould cavity 156 via the injection point/channel 160, as illustrated in FIG. 6.

The second polymeric material 22 injected into the cavity 156 fills the core of the cavity 156 and pushes the molten core Li of the first polymeric material 20 that reaches all remaining internal surfaces of the mould 150 where at least partially solidifies.

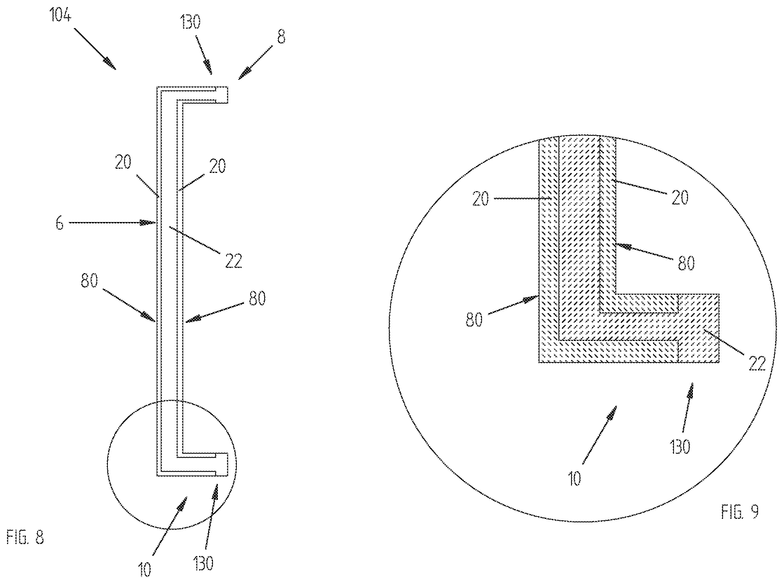

The second polymeric material 22 is injected into the cavity 156 for a second time T2. At the end of the second time T2, the second molten polymeric material 22 fills completely the core of the support body 4 and is completely surrounded by the first polymeric material 20, as illustrated in FIG. 7. The first polymeric material 20, in turn, reaches all the remaining internal surfaces of the mould 150 and completely covers the second polymeric material 22.

At the end of the second time T2, the injection of material into the cavity 156 is stopped. The first polymeric material 20 and the second polymeric material 22 then completely solidified, preferably through heating of the mould 150, and the mould 150 may be finally opened and the support body 4 extracted therefrom.

It has to be noted that in the figures the first polymeric material and the second polymeric material are shown as clear separate layers. It is clear that the first polymeric material and the second polymeric material preferably partially penetrate each other for a small section so as to form a one-piece monolithic body.

FIGS. 8 and 9 show a further preferred embodiment of a support body 104 according to the invention. This support body 104 differs from the support body 4 previously described with reference to FIGS. 2 and 3 in that the external surface 80 of the support body 104 is not totally constituted by the first polymeric material 20. End portions 130 of the mounting ribs 8, 10 are constituted by the second polymeric material 22.

The first polymeric material 20, therefore, partially covers the second polymeric material 22. The second polymeric material 22 constitutes the core of the support body 104 and, in part, constitutes the external surface 80 of the support body 104.

The end portions 130 constituted by the second recycled polymeric material 22 are preferably not visible from outside when the user control panel is assembled on the laundry washing machine.

With reference to FIGS. 10 to 12 a method to obtain a support body 104 according to the second preferred embodiment of the invention is described.

Preferably, a moulding injection process is used to obtain the support body 104.

The same mould 150 described above is used to obtain the support body 104.

FIG. 10 shows a first phase of the injection process.

A first molten polymeric material 20, preferably a not recycled polymeric material, is forced into the mould cavity 156 via the injection point/channel 160.

The first polymeric material 20 injected into the cavity 156 that touches the internal surfaces (walls) of the mould 150 cools rapidly and at least partially polymerises due to the low wall temperature of the mould 150. At this stage, as illustrated in FIG. 10, an external layer Le of first solidified polymeric material 20 encloses a molten core Li of first polymeric material 20.

The first polymeric material 20 is injected into the cavity 156 for a first time T1′.

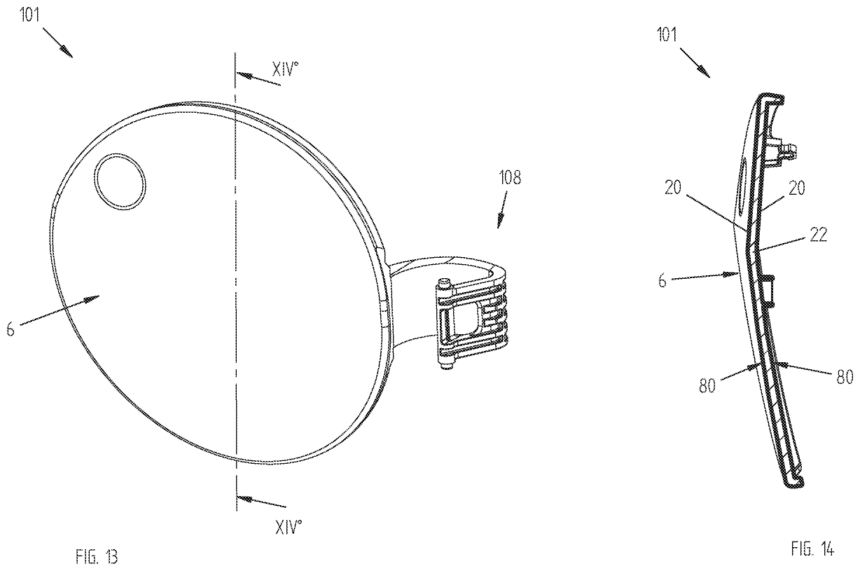

From the end of the first time T1′ the second molten polymeric material 22, preferably a recycled polymeric material, is subsequentially and continuously forced into the mould cavity 156 via the injection point/channel 160, as illustrated in FIG. 11.

The second polymeric material 22 injected into the cavity 156 fills the core of the cavity 156 and pushes the molten core Li of the first polymeric material 20. All the first polymeric material 20 distributes over the internal surfaces of the mould 150 where at least partially solidifies, except for the end portions 130.

The second polymeric material 22 is injected into the cavity 156 for a second time T2′. The second polymeric material 22 reaches the end portions 130 where at least partially solidifies.

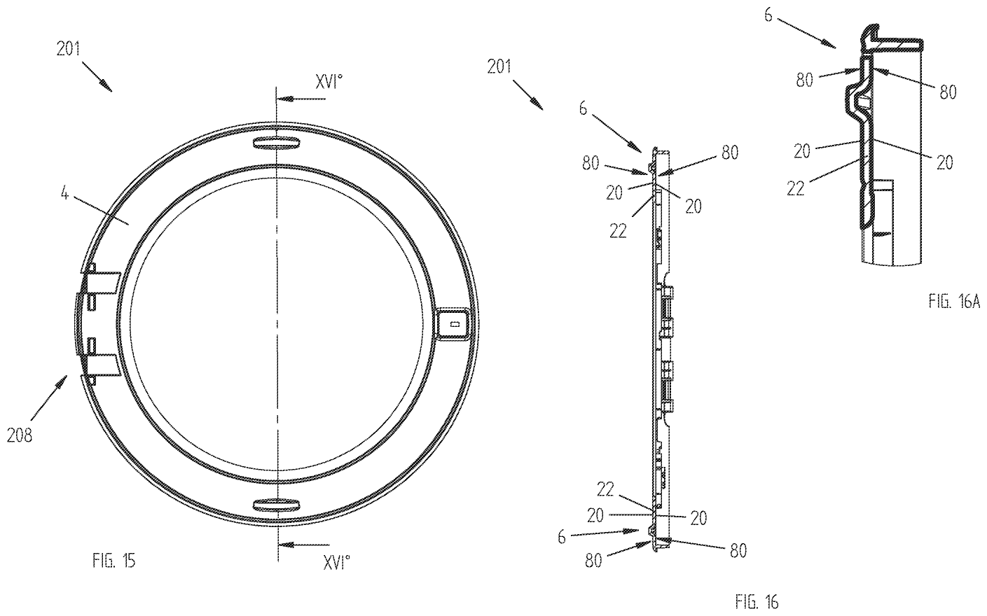

The second molten polymeric material 22 fills the core of the support body 104 and also the end portions 130, as illustrated in FIG. 12.

At the end of the second time T2′, the injection of material into the cavity 156 is stopped. The first polymeric material 20 and the second polymeric material 22 then completely solidified, preferably through heating of the mould 150, and the mould 150 may be finally opened and the support body 104 extracted therefrom.

The method above described to obtain an aesthetic component according to the invention, for example a user interface, eventually carries out a co-injection moulding process wherein the first polymeric material and the second polymeric material are injected, one after the other, into the same mould.

With reference to FIGS. 13 and 14 a further preferred embodiment of a component 101 according to the invention is shown. In the drawings, corresponding characteristics and/or components compared to first preferred embodiment are identified by the same reference numbers.

The component 101 refers to a filter door 101 which is preferably arranged at a frontal side of a laundry washing machine (not shown) so that a user may easily access the filter, for example for cleaning it.

The filter door 101 preferably has a substantially planar frontal surface 6 and comprises a hinge 108 suited to mount the filter door 8 to the frontal side of the laundry washing machine.

The planar frontal surface 6 represents the surface of the filter door 101 which is visible from outside when the filter door 101 is assembled on the laundry washing machine.

According to an aspect of the invention, the filter door 101 preferably comprises a first polymeric material 20 and a second polymeric material 22, as better illustrated in FIG. 14.

The first polymeric material 20 constitutes the external surface 80 of the filter door 101 and covers the second polymeric material 22.

In the preferred embodiment here described, the first polymeric material 20 constitutes the overall external surface 80 of the filter door 101 and completely covers the second polymeric material 22.

The second polymeric material 22 constitutes the core of the filter door 101 and is completely surrounded by the first polymeric material 20.

The filter door 101 is preferably obtained through a continuous injection moulding process as described above with reference to the first embodiment.

The filter door 101 is preferably obtained through a continuous injection moulding process wherein the first polymeric material 20 and the second polymeric material 22 are sequentially and continuously injected in a mould.

With reference to FIGS. 15 to 16A a further preferred embodiment of a component 201 according to the invention is shown. In the drawings, corresponding characteristics and/or components compared to previous preferred embodiments are identified by the same reference numbers.

The component 201 refers to a door frame 201 which is preferably arranged at a frontal side of a laundry washing machine (not shown) so that a user may easily access the washing drum.

The door frame 201 preferably has a substantially planar annular frontal surface 6 and comprises a hinge system 208 suited to mount the door frame 201 to the frontal side of the laundry washing machine.

The planar frontal surface 6 represents the surface of the door frame 201 which is visible from outside when the door frame 201 is assembled on the laundry washing machine.

According to an aspect of the invention, the door frame 201 preferably comprises a first polymeric material 20 and a second polymeric material 22, as better illustrated in FIG. 16A.

The first polymeric material 20 constitutes the external surface 80 of the door frame 201 and covers the second polymeric material 22.

In the preferred embodiment here described, the first polymeric material 20 constitutes the overall external surface 80 of the door frame 201 and completely covers the second polymeric material 22.

The second polymeric material 22 constitutes the core of the door frame 201 and is completely surrounded by the first polymeric material 20.

The door frame 201 is preferably obtained through a continuous injection moulding process as described above with reference to the first embodiment.

The door frame 201 is preferably obtained through a continuous injection moulding process wherein the first polymeric material 20 and the second polymeric material 22 are sequentially and continuously injected in a mould.

It has thus been shown that the present invention allows all the set objects to be achieved. In particular, it makes it possible to optimize mechanics and/or aesthetics characteristics of plastic components on the base of the type of plastic material used in the producing process.

While the present invention has been described with reference to the particular embodiments shown in the figures, it should be noted that the present invention is not limited to the specific embodiments illustrated and described herein; on the contrary, further variants of the embodiments described herein fall within the scope of the present invention, which is defined in the claims.

1. An aesthetic component of a water bearing appliance, component comprising:
a first polymeric material; and
a second polymeric material
wherein:
the first polymeric material defines at least part of an external surface of said component with said first polymeric material covering said second polymeric material, and
wherein said second polymeric material comprises a recycled polymeric material.

2. The component according to claim 1, wherein said first polymeric material does not comprise a recycled polymeric material.

3. The component according to claim 1, wherein said external surface of said component is completely constituted by said first polymeric material and said first polymeric material completely covers said second polymeric material.

4. (canceled)

5. The component according to claim 1, wherein said first polymeric material and/or said second polymeric material comprises a thermoplastic material.

6. The component according to claim 1, wherein said recycled material derives from post-consumer plastic and/or post-industrial plastic materials.

7. The component according to claim 1, wherein:
said recycled material comprises a polymeric material comprising one or more chemical elements of the group comprising the following chemical elements: Lead; Cadmium; Mercury; Hexavalent Chromium; Bromine; Antimony; and Arsenic; and
said one or more chemical elements can be found in a respective quantity inside said recycled material above, or equal to, a respective minimum threshold amount.

8. The component according to claim 7, wherein:
said one or more chemical elements comprises Lead and the respective minimum threshold amount for Lead is 7 ppm;
said one or more chemical elements comprises Cadmium and the respective minimum threshold amount for Cadmium is 5 ppm;
said one or more chemical elements comprises Mercury and the respective minimum threshold amount for Mercury is 0.01 ppm;
said one or more chemical elements comprises Hexavalent Chromium and the respective minimum threshold amount for Hexavalent Chromium is 10 ppm;
said one or more chemical elements comprises Bromine and the respective minimum threshold amount for Bromine is 5 ppm;
said one or more chemical elements comprises Antimony and the respective minimum threshold amount for Antimony is 5 ppm; and/or
said one or more chemical elements comprises Arsenic and the respective minimum threshold amount for Arsenic is 5 ppm.

9. The component according to claim 7, wherein said recycled material derives from polyolefin polymers, wherein said one or more chemical elements can be found in a respective quantity inside said recycled material below, or equal to, a maximum respective threshold amount, and wherein:
said one or more chemical elements comprises Lead and the respective maximum threshold amount for Lead is 60 ppm;
said one or more chemical elements comprises Cadmium and the respective maximum threshold amount for Cadmium is 20 ppm;
said one or more chemical elements comprises Mercury and the respective maximum threshold amount for Mercury is 0.5 ppm;
said one or more chemical elements comprises Hexavalent Chromium and the respective maximum threshold amount for Hexavalent Chromium is 20 ppm;
said one or more chemical elements comprises Bromine and the respective maximum threshold amount for Bromine is 60 ppm;
said one or more chemical elements comprises Antimony and the respective maximum threshold amount for Antimony is 50 ppm; and/or
said one or more chemical elements comprises Arsenic and the respective maximum threshold amount for Arsenic is 50 ppm.

10. The component according to claim 7, wherein said recycled material derives from styrenic polymers, wherein said one or more chemical elements can be found in a respective quantity inside said recycled material below, or equal to, a respective maximum threshold amount, and wherein:
said one or more chemical elements comprises Lead and the respective maximum threshold amount for Lead is 90 ppm;
said one or more chemical elements comprises Cadmium and the respective maximum threshold amount for Cadmium is 40 ppm;
said one or more chemical elements comprises Mercury and the respective maximum threshold amount for Mercury is 10 ppm;
said one or more chemical elements comprises Hexavalent Chromium and the respective maximum threshold amount for Hexavalent Chromium is 100 ppm;
said one or more chemical elements comprises Bromine and the respective maximum threshold amount for Bromine is 100 ppm;
said one or more chemical elements comprises Antimony and the respective maximum threshold amount for Antimony is 200 ppm; and/or
said one or more chemical elements comprises Arsenic and the respective maximum threshold amount for Arsenic is 200 ppm.

11. The component according to claim 1, wherein said first polymeric material and said second polymeric material form a one-piece monolithic body.

12. The component according to claim 1, wherein said first polymeric material and said second polymeric material are co-injected material resulting from a co-injection moulding process.

13. The component according to claim 1, wherein said component is one of: a casing component of said water bearing appliance, and a control panel of said water bearing appliance.

14. A method for producing an aesthetic component comprising a first polymeric material; and a second polymeric material, wherein: the first polymeric material defines at least part of an external surface of said component with said first polymeric material covering said second polymeric material, and wherein said second polymeric material comprises a recycled polymeric material; the method comprising:
injecting from at least one injection point said first polymeric material into a cavity of a mould for a first time so that said first polymeric material reaches internal surfaces of said mould and at least partially solidifies to form an external solidified layer; and
injecting from said at least one injection point, after said first time, said second polymeric material into said mould for a second time so that said second polymeric material fills the core of said cavity and pushes the first polymeric material not yet solidified.

15. The method according to claim 14, wherein said second polymeric material pushes said first polymeric material not yet solidified so that said first polymeric material reaches all remaining internal surfaces of said mould where said first polymeric material at least partially solidifies and forms an external solidified layer.

16. The method according to claim 14, wherein said second polymeric material pushes said first polymeric material not yet solidified so that said first polymeric material reaches some remaining internal surfaces of said mould where said first polymeric material at least partially solidifies and forms an external solidified layer and so that said second polymeric material reaches all remaining internal surfaces of said mould where said second polymeric material at least partially solidifies and forms an external solidified layer.
